(19) United States
(12) Patent Application Publication
(10) Pub. No.: US 2010/0100966 A1
(43) Pub. Date: Apr. 22, 2010

(54) METHOD AND SYSTEM FOR BLOCKING INSTALLATION OF SOME PROCESSES

(75) Inventor: Laurence HAMID, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: MEMORY EXPERTS INTERNATIONAL INC., Montreal (CA)

(21) Appl. No.: 12/581,964

(22) Filed: Oct. 20, 2009

Related U.S. Application Data
(60) Provisional application No. 61/106,998, filed on Oct. 21, 2008.

(51) Int. Cl. G06F 7/04; G06F 21/22

(52) U.S. Cl. 726/26

(57) ABSTRACT

A method includes providing a processor comprising memory for storing of blacklist data therein and memory for storing of programming data therein for execution on the processor. Version data indicative of a version of first programming data is retrieved from memory external to the processor. The version data is compared with blacklist data stored within the processor. When the blacklist data is indicative of the version data indicating a version of the programming data that is blacklisted, then the processor other than executes the first programming data.

### FIELD OF THE INVENTION

The invention relates to electronic processing circuits and more particularly to storing of code for execution by the electronic processing circuit outside of the circuit.

### BACKGROUND

Microprocessors are used in many applications across many fields and have now become relatively ubiquitous. A typical general purpose microprocessor includes processing circuitry, read only memory (ROM) for storing of microcode for defining the microprocessors instruction set, register data memory, and memory for caching of instruction and other data. The microcode typically is stored in read only memory within the microprocessor.

A typical special purpose or custom processor includes some or all of the same elements as a general purpose processor but whereas the general purpose processor includes ROM for storing of microcode, a special purpose processor may also include ROM for storing of special purpose programming as well. This allows for more complete solutions to be provided—a processor for performing function X—and reduced parts count. A field that has readily accepted this architecture is the field of electronic security wherein storing the software code for a security device within ROM of the custom processor significantly reduces a risk of tampering.

Unfortunately, two problems flow from this common approach. Firstly, upgrading the software code within the ROM poses many security risks that are both problematic and reduce the benefits of storing the software code in ROM. Secondly, in the design of custom processors, a significant amount of ROM is required for software code storage.

It would be advantageous to provide a processing circuit that overcomes drawbacks of the prior art.

### SUMMARY OF THE INVENTION

In accordance with an aspect of the invention there is provided a method comprising: providing a processor comprising memory for storing of blacklist data therein and memory for storing of programming data therein for execution on the processor; retrieving, from memory external to the processor, version data indicative of a version of first programming data; comparing the version data with blacklist data stored within the processor; and, when the blacklist data is indicative of the version data indicating a version of the programming data that is blacklisted, other than executing the first programming data by the processor.

In accordance with another aspect of the invention there is provided an apparatus comprising: a processor comprising non-volatile memory for storing of blacklist data therein and memory for storing of programming data therein for execution on the processor and for: retrieving, from a memory external to the processor, version data indicative of a version of first programming data; comparing the version data with the blacklist data; and, when the blacklist data is indicative of the version data indicating a version of the programming data that is blacklisted, other than executing the first programming data by the processor.

In accordance with another aspect of the invention there is provided an apparatus comprising: a processor comprising non-volatile memory for storing of blacklist data therein and memory for storing of programming data therein for execution on the processor and for: retrieving, from a memory external to the processor, version data indicative of a version of first programming data; comparing the version data with the blacklist data; and, when the blacklist data is indicative of the version data indicating a version of the programming data that is blacklisted, other than storing the first programming data within the processor for execution thereon.

### BRIEF DESCRIPTION OF THE DRAWINGS

The invention will now be described with reference to the attached drawings in which:

FIG. 1A is a simplified block diagram of an integrated processing circuit;

FIG. 1B is a simplified flow diagram of a process for upgrading of an integrated processing circuit ROM;

FIG. 1C is a simplified flow diagram of a process for an integrated processing circuit to load application program data in paged format;

FIG. 2 is a simplified flow diagram of a method of preventing installation of known flawed firmware;

FIG. 3 is a simplified flow diagram of another method of preventing installation of known flawed firmware;

FIG. 4 is a simplified flow diagram of a method of loading executable code into a processor RAM; and,

FIG. 5 is a simplified flow diagram of a method of updating blacklist data.

### DETAILED DESCRIPTION OF EMBODIMENTS OF THE INVENTION

In security software development, software that is believed to be secure is often found, at a later time, to not be so. Once discovered, a known hazard in an already released software product is often corrected with a patch. A patch is typically a small installation that replaces some portions of installed software to correct known problems because, once known, a security problem is more easily and readily exploited. Therefore, patch distribution and installation is commonly as rapid as possible.

Once a security problem is publicly discussed, many individuals could launch security attacks on any system having the problem based on knowledge of the known problem. When, for example, a security problem is found in an operating system, attacks launched at all systems with the operating system in execution thereon will be quite successful much of the time, at least until the patch is installed on most of the systems; only patched systems are immune from said attacks. Patches vary from replacing a few lines of programming code to replacing entire routines and/or functions to replacing most or all of an application.

For custom processing systems, the above poses an interesting problem. If a custom system allows for patching, then the custom system is repairable. If not, then the system is insecure once a known problem is found. As such, allowing for patching of application program data within any system is beneficial. For custom systems, this is often done with a firmware upgrade following steps such as the following:

receive a firmware upgrade patch file;

verify that the firmware upgrade patch is from an authorized firmware upgrade source;

replace the current firmware in ROM with the upgraded firmware from the firmware upgrade file; and

execute the new firmware.

Unfortunately, if a known problem exists within a version of the firmware, an unscrupulous party could get a copy of that firmware version and install it, for example, as an upgrade on systems in order to exploit the flaw. By replacing the firmware with a firmware version having a known flawed version, breaching of the system security is facilitated. For this reason, security systems typically have some level of physical or logical security to prevent unauthorized firmware upgrades. These include, for example, password protection or physically securing the firmware upgrade file.

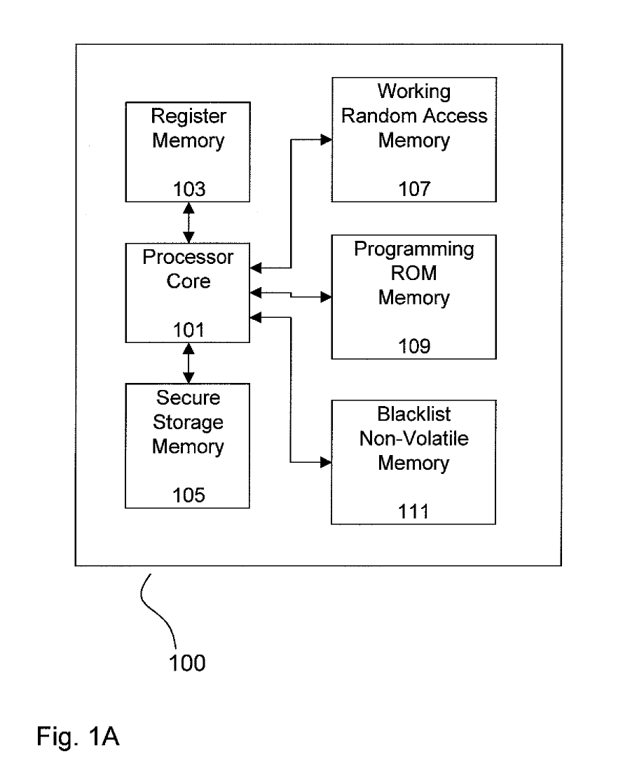

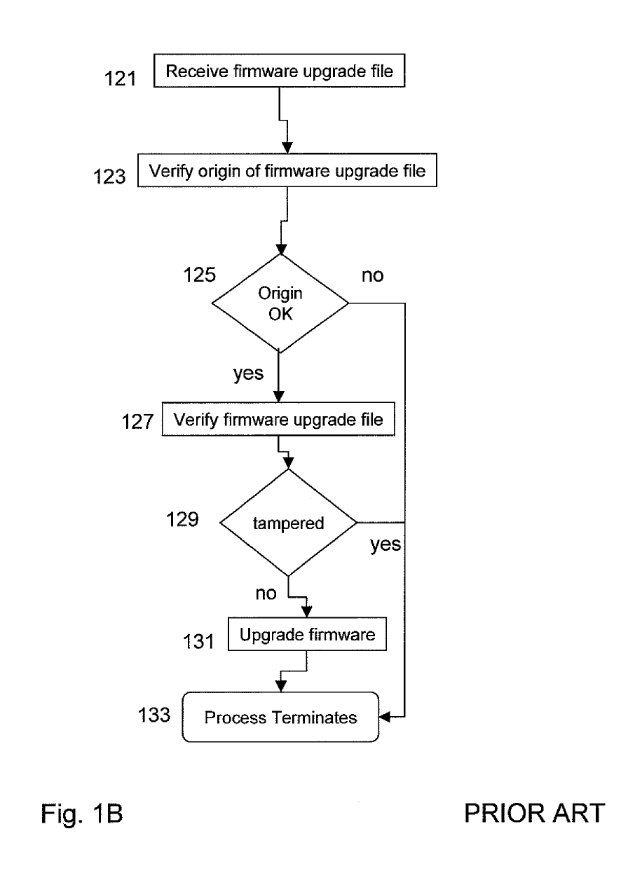

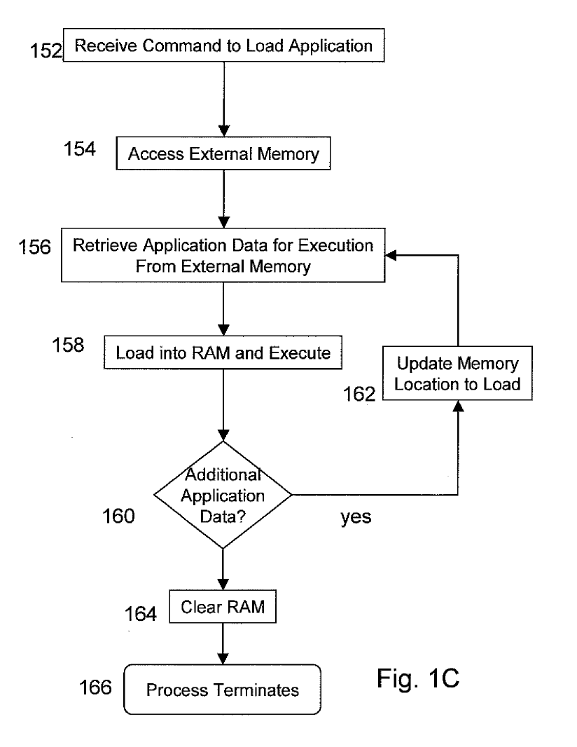

Referring to FIG. 1A, a simplified block diagram of an integrated processor circuit 100 is shown. For example, the processing circuit is an ASIC. Alternatively, it comprises a programmable logic device. Further alternatively, it comprises a processor designed and manufactured in other known fashions. The integrated processor circuit 100 comprises a processor core 101, register memory 103, secure storage memory 105, working random access memory (RAM) 107, a programming ROM memory 109, and a blacklist non-volatile memory 111. Operation of the processor core 101 is in accordance with known processor operation. Operation of the integrated processor circuit 100 is described hereinbelow.

Referring to FIG. 1B, there is a shown a simplified flow diagram of a method of replacing firmware within a processor according to the prior art. At 121 a firmware upgrade patch file is received. At 123, the firmware upgrade patch is verified to determine that it is from an authorized firmware upgrade source in the form of a hardware provider for the processor and a decision is made at 125. When it is not determined to be from an authorized source, the firmware upgrade is terminated at 133. When it is determined to be from an authorized source, the firmware upgrade file is verified to have other than been tampered with at 127 and a decision is made at 129. When the firmware upgrade file is determined to have been tampered with, the firmware upgrade is terminated at 133. When the firmware upgrade file is determined to have other than been tampered with, the current firmware in ROM is replaced with upgraded firmware extracted from the firmware upgrade file at 131. Finally, the new firmware is executed, for example by resetting the hardware device.

Referring to FIG. 1C, there is shown a simplified flow diagram for an integrated processing circuit, such as integrated processor circuit 100, loading an application into RAM in a paged format. The process begins at 152 wherein an integrated processor receives a command to load an application for execution, such as a security based verification and authorization application for a financial transaction wherein the application is executed within a secure USB memory drive. At 154 the process accesses an external memory to establish the initial memory location of the application. At 156 the process retrieves application data for execution from the external memory that starts at the initial memory location identified at 154. The amount of retrieved application data is limited to that supported by the RAM of the integrated processor. Typically, the paged application data has been secured and stored by the processor at an earlier time.

As the RAM of the integrated processor is significantly smaller than the application data requirements, the process retrieves a maximum amount of application data that is supported by the RAM. Alternatively, the process retrieves a predetermined amount of application data, commonly referred to as a page. At 158 the integrated processor executes the application data from RAM. At 160 the integrated processor establishes upon execution of first data whether additional application data is to be loaded. If more application data is to be loaded the process returns to 162 wherein a memory location from which to load further data is determined. The process then continues to 156 and cycles through a loop while additional application data remains to be loaded. Alternatively, the application returns to previous stages of execution requiring reloading of previous pages of application data, such a scenario not indicated within the simplified flow diagram.

At 160 when no additional application data is to be loaded then the process continues at 164 where RAM is cleared and the process terminates at 166. More typically, the process continues until some time when a termination of the process is separately initiated. Of note, when the RAM is other than non-volatile RAM, disconnecting power from the processor results in clearing of the RAM without any specific step for clearing of the RAM.

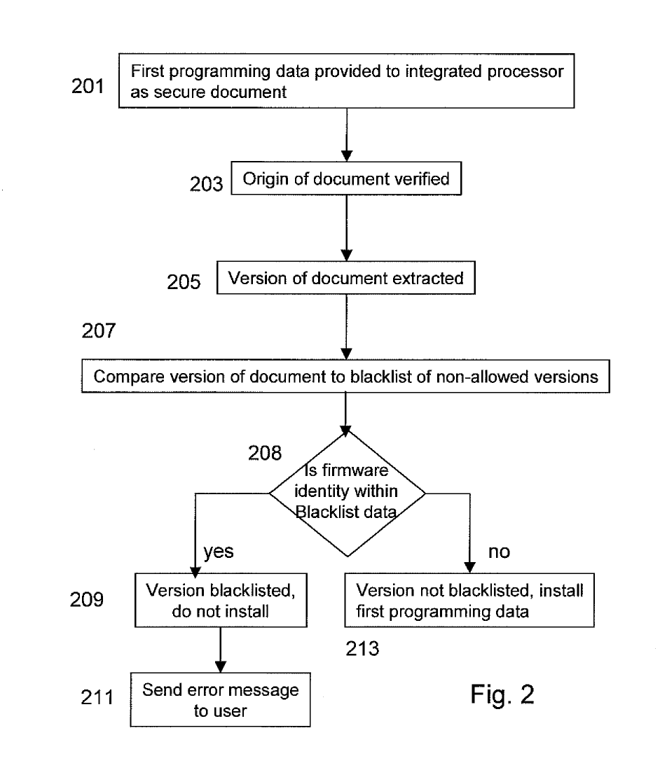

Referring to FIG. 2, a simplified flow diagram of a method of preventing installation of known flawed firmware is shown. When upgrading of the processor programming ROM memory, first programming data is provided at 201 to the integrated processor circuit 100 as a secured document including data therein indicative of an origin of the document and a version of the document. The origin of the document is verified at 203 to ensure that the document originates from an authorized programming provider in the form of a hardware vendor. Once verified, a version data in the form of a version identifier for the document is extracted at 205 to indicate, for example, a software version. Alternatively, a build version, or other indicator is used. The version data of the document is compared to at least blacklist data of non-allowed versions at 207 to determine that the version of the document is other than precluded from being installed and at 208, a decision is made. At 209, when the version is determined to be blacklisted, it is not installed and an error message is returned to a user at 211. Alternatively, an error message is other than returned to the user. At 213, when the version of the document is other than blacklisted, the first programming data is installed.

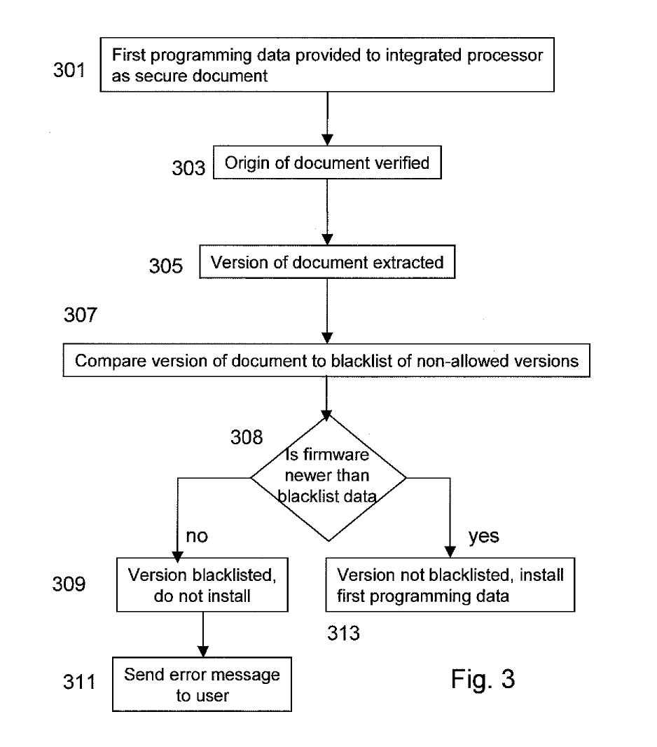

Referring to FIG. 3, a simplified flow diagram of another method of preventing installation of known flawed firmware is shown. When upgrading of the processor programming ROM memory, programming is provided at 301 to the integrated processor circuit as a secured document including data therein indicative of an origin of the document and a version of the document. The origin of the document is verified at 303 to ensure that the document originates from an authorized programming provider in the form of a hardware vendor by, for example, comparing an encrypted hash of the document with a database of encrypted hashes stored within the processor programming ROM. Alternatively, another form of verifying the origin of the document is used. Once the origin has been verified, a version data in the form of a version identifier of the document is extracted at 305 to indicate, for example, a software version. Alternatively, a build version, or other indicator is used. The version data of the document is compared to blacklisted data at 307 to determine that the version of the document is other than precluded from being installed and at 308, a decision is made. At 309, when the version is other than newer than a version of the firmware indicated by the blacklisted version, it is other than installed and an error message is returned to a user at 311. Alternatively, no error message is returned to the user. At 313, when the version of the document is newer than a version of the document indicated by the blacklisted version, the programming is installed. Alternatively, the process accesses a database of known secure versions and installs the version only if it is a known secure version.

The above noted examples refer to upgrading the processor programming ROM memory. An example of upgrading a processor ROM is termed in the art “flashing” the processor ROM. Alternatively, instead of updating processor ROM, ROM external to the processor has executable code stored therein for loading into RAM prior to execution thereof.

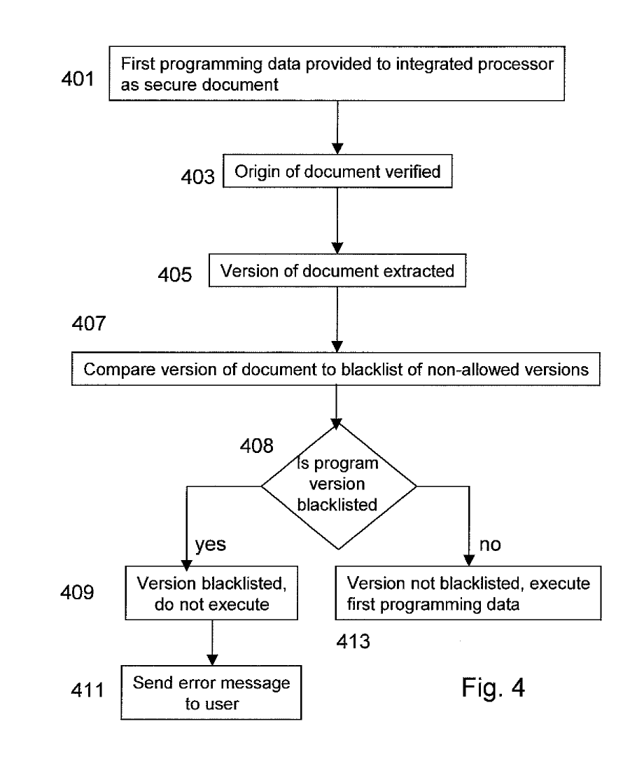

Referring to FIG. 4, a simplified flow diagram of a method of loading executable code in to a processor RAM is shown. Programming is provided at 401 to the integrated processor circuit as a secured document including data therein indicative of an origin of the document and a version of the document. The origin of the document is verified at 403 to ensure that the document originates from an authorized programming provider in the form of a hardware vendor. Once verified, version data in the form of a version identifier of the document is extracted at 405 to indicate, for example, a software version. Alternatively, a build version, or other indicator is used. The version identifier of the document is compared to at least stored blacklisted data at 407 to determine that the version of the document is other than precluded from being executed. At 409, when the version is blacklisted, it is not executed and, optionally, an error message is returned to a user at 411. At 413, when the version of the document is other than blacklisted, the programming is executed on the processor. Advantageously, each time the processor is reset, the programming is reloaded, thereby allowing for blacklisting of current programming which will take effect upon resetting or re-powering of the processor.

In the above described embodiment, the blacklist data indicates one or more versions of the application. Alternatively, the blacklist data is a version before which all versions are blacklisted. In yet another embodiment, a combination of the listed blacklisted version identification techniques is used. One of skill in the art will appreciate that there are many ways to store blacklist data indicative of blacklisted versions of programming and that these, when suitable, are usable in accordance with the present invention.

An example of data therein indicative of an origin of the document is digital signature data providing a digital signature of the programming data allowing for verification of the signer of the programming data and thus determination of the origin. As will be known in the art of computer security, digital certification and certificates are useful in the verification of digitally signed data and are optionally used in accordance with the above embodiments to verify an origin of the programming data.

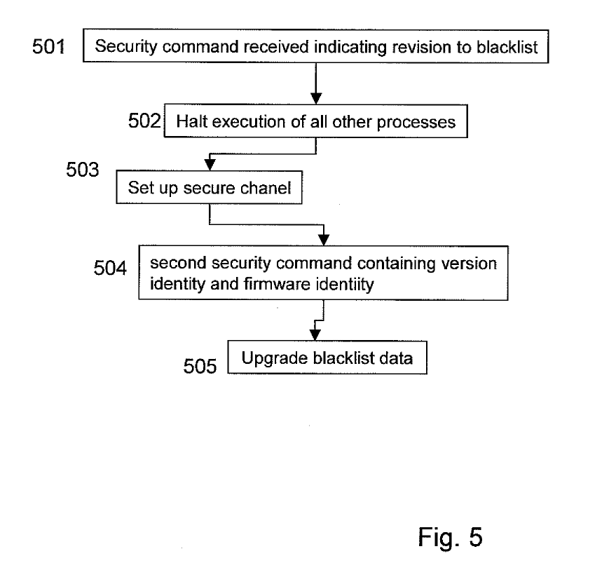

Referring to FIG. 5, a simplified flow diagram of a method of updating blacklist data relating to blacklisted versions is shown. When a manufacturer patches a security problem, the manufacturer indicates the prior released version with the security problem as blacklisted.

Beginning at 501 a security command is provided to an integrated processor, the security command indicating that a revision to blacklist data stored within ROM of the integrated processor is being provided. At 502 the integrated processor halts execution of any other processes in execution and prepares to receive a subsequent security command. At 503 a secure channel is established between the manufacturer and the integrated processor. Typically, the secure channel is formed using encryption of data. Often this involves a session key. Alternatively, it involves asymmetric encryption keys. Further alternatively, it involves symmetric encryption keys. At 504 a second security command is provided to the integrated processor comprising data indicative of a version to be added to the blacklist data. In an embodiment, this comprises a version number. Alternatively, it comprises a version number and a software application identifier. The integrated processor updates blacklist data stored therein to reflect the new blacklist data. Preferably, the update maintains any existing blacklisted versions as blacklisted. For example, the integrated processor stores a version number that is highest of provided version numbers such that any version prior to a last blacklisted version is also blacklisted. Alternatively, the integrated processor maintains a list of blacklisted versions. The updated blacklist data is stored in ROM within the integrated processor. Storing of the blacklist data within ROM prevents tampering therewith other than by the integrated processor as it is accessible only via the integrated processor.

Optionally, the update data provided to the integrated processor comprises new firmware for being stored within the integrated processor or accessible thereto provided with firmware identity and revision identity. Optionally, the integrated processor automatically updates the blacklist data in dependence upon at least one of the firmware identity and revision identity.

Alternatively the integrated processor triggers contact to a remote controller for an update of blacklist data relating to blacklisted of versions of firmware. Such a trigger for example is optionally on a per use basis, at intervals based on elapsed time, after a predetermined number of firmware executions, or upon detecting a change to a firmware stored externally in RAM prior to loading the firmware.

In some instances the integrated processor receives an indication that a firmware version currently stored either internally or externally within RAM is blacklisted without receiving an updated version of the firmware. Optionally in this event the device enters a frozen state preventing further operations until the device has been returned to a system administrator allowing the firmware to be updated and the blacklist revised within a secure environment. Further optionally, the device enters a frozen state pending receipt of non-blacklisted firmware.

Alternatively, blacklist data is maintained for portions of firmware or software application data allowing blacklisting of some portions and not others. For example, when software application data is stored outside the integrated processor in a paged fashion, each individual page has associated version data and associated blacklist data allowing for individual pages to blacklisted. Alternatively, the entire paged software application data is related to a same blacklist data and is blacklisted or not in its entirety.

Though blacklisting has been described with reference to firmware and to secure software application data, it also applies to unsecure application data. Optionally, blacklisting is applied to data. For example, for policy data, it is advantageous to be able to blacklist some previous policy data. For example, when an authentication policy is upgraded to a 2-factor authentication, for example biometric and password, it is desirable to prevent a downgrade returning to single factor authentication by installing the old policy data file. Alternatively, the method is used to invalidate a cryptographickey. For example an embedded processor may not be able to do a revocation check on a certificate but it can check a blacklist internally, thereby preventing it from communicating with a compromised or untrusted host.

In accordance with an embodiment of the invention, the version data comprises a hash of the first programming data. Optionally, the version data is stored with the first programming data. Further optionally, the hash is computed to determine the version data as part of retrieving the version data. Typically, when the version data comprises a hash, previous versions and subsequent versions are other than identifiable from the version data as it is typically not sequential in nature. Alternatively, the first programming data is arranged such that the version data follows an approximate sequence.

Numerous other embodiments of the invention will be apparent to persons skilled in the art without departing from the scope of the invention as defined in the appended claims.

What is claimed is:

1. A method comprising:
providing a processor comprising memory for storing of blacklist data therein and memory for storing of programming data therein for execution on the processor;
retrieving, from memory external to the processor, version data indicative of a version of first programming data;
comparing the version data with blacklist data stored within the processor; and,
when the blacklist data is indicative of the version data indicating a version of the programming data that is blacklisted, other than executing the first programming data by the processor.

2. A method according to claim 1 comprising:
when the blacklist data is indicative of the version data indicating a version of the first programming data that is blacklisted, other than storing the first programming data within the memory for execution.

3. A method according to claim 1 wherein retrieving comprises:
retrieving from the memory external to the processor the first programming data, the first programming data comprising the version data.

4. A method according to claim 1 comprising:
starting the processor;
retrieving, from the memory, start-up programming code to execute on the processor; and
executing the start-up programming code on the processor, the start-up programming code for retrieving the version data of the first programming data.

5. A method according to claim 4 wherein the start-up programming code is stored within memory integral to the processor.

6. A method according to claim 1 wherein, the blacklist data stored within the processor comprises a list of blacklisted versions of the first programming data.

7. A method according to claim 1 wherein, the blacklist data stored within the processor comprises an indication of one of a last blacklisted version of the first programming data and a first non-blacklisted version of the first programming data, versions of the first programming data previous to the first non blacklisted version all being blacklisted.

8. A method according to claim 1 wherein the blacklist data stored within the processor is modified each time first programming data is successfully retrieved and executed.

9. A method according to claim 8 wherein the blacklist data stored within the processor comprises version data relating to programming stored within the processor.

10. A method according to claim 9 wherein version data indicating a version previous to the blacklist data is indicative of a blacklisted version of first programming data.

11. A method according to claim 1 wherein the processor is absent sufficient internal non-volatile memory for storing of the first programming data in ROM thereof.

12. A method according to claim 1 wherein the blacklist data stored within the processor is stored in non-volatile memory integrated within the processor.

13. A method according to claim 1 wherein upon initialization, the processor retrieves programming data from memory external thereto and other than stores thereon first programming data for execution subsequent to an initialization operation.

14. A method according to claim 1 wherein the blacklist data stored within the processor is modified by another process employing secure communication with a provider of blacklist data.

15. A method according to claim 1 comprising:
retrieving from a server external to the processor blacklist data, the blacklist data retrieved securely; and,
storing the blacklist data within non-volatile memory of the processor.

16. An apparatus comprising:
a processor comprising non-volatile memory for storing of blacklist data therein and memory for storing of programming data therein for execution on the processor and for:
retrieving, from a memory external to the processor, version data indicative of a version of first programming data;
comparing the version data with the blacklist data; and
when the blacklist data is indicative of the version data indicating a version of the programming data that is blacklisted, other than executing the first programming data by the processor.

17. An apparatus comprising:
a processor comprising non-volatile memory for storing of blacklist data therein and memory for storing of programming data therein for execution on the processor and for:
retrieving, from a memory external to the processor, version data indicative of a version of first programming data;
comparing the version data with the blacklist data; and,
when the blacklist data is indicative of the version data indicating a version of the programming data that is blacklisted, other than storing the first programming data within the processor for execution thereon.
